(19) United States
(12) Patent Application Publication
(10) Pub. No.: US 2020/0198988 A1
(43) Pub. Date: Jun. 25, 2020

(54) Process for Making Gemstone Infused Water Using a Perforated Glass Container

(71) Applicant: Arthur Leslie Berger, Tallahassee, FL (US)

(72) Inventor: Arthur Leslie Berger, Tallahassee, FL (US)

(21) Appl. No.: 16/231,542

(22) Filed: Dec. 23, 2018

(51) Int. Cl. C02F 1/00

(52) U.S. Cl. CPC C02F 1/001; B01D 23/10

(57) ABSTRACT

A process for making gemstone infused water (also referred to as gemstone elixirs) by placing gemstones into a perforated glass container, and then pouring water into the perforated glass container and over the gemstones. The water comes into contact with the gemstones but does not come into contact with any other material except the glass of the perforated glass container and the glass of the glass collection container. After being poured into the perforated glass container and over the gemstones, the water drains or passes through the perforations located at or near the bottom of the perforated glass container and into the glass collection container where it is then available for consumption or storage. The gemstones can remain inside the perforated glass container for repeated or future use. This sequence of steps can be repeated multiple times for the same batch of water or a new batch of water.

### CROSS-REFERENCE TO RELATED APPLICATIONS

This application claims the benefit of provisional process patent Application No. 62/726,366, filed Sep. 3, 2018 by the present inventor.

### BACKGROUND

### Prior Art

No known patented prior art.

### Alternative Methods

There is a growing interest in using gemstones to energetically vitalize and enhance the wellbeing of the physical body. In the book “Wisdom of the Gemstone Guardians” by Michael Katz, for example, the benefits of gemstones are discussed in great detail. Gemstones have been used throughout history for their vitalizing qualities. For example, old Buddhist texts mention that Buddha himself used gemstones for healing purposes. Concurrent with today's interest in using the vitalizing qualities of gemstones is ongoing research by scientists into the theory that water has memory. This topic is discussed in the books “Water and its memory: New and astonishing insights into water research,” by Bernd Kröplin and Regine C. Hensche, and “Water Knows the Answer: Each Drop of Water Has Its Own Memory,” by Jiang Ben Sheng. This research suggests that water may be an excellent vehicle to carry the energetic qualities of gemstones into the physical body. Other sources of information on the use of gemstones to enhance physical wellbeing include:

(a) Joachim Goebel & Michael Gienger, Gem Water: How to Prepare and Use More than 130 Crystal Waters for Therapeutic Treatments (2008).

(b) Cindy Walker, Crystal Guide: Healing with Gemstone Infused Waters, Elixirs and Massage Oils (2015).

(c) Karen E. Wood, Working with the Mineral Kingdom: A Gemstone Elixir Recipe Book (2017).

(d) T. S. Chen & P. S. Chen, The Healing Buddha, 12 Journal of Medical Biography, 239 (2004).

(e) Flora Peschek-Bohmer & Gisela Schreiber, Healing Crystals and Gemstones: From Amethyst to Zircon (2002).

The specific use of the gemstone Aquamarine is discussed in the book “Aquamarine Water—Fountain of Youthful Vitality” by Michael Katz. The method recommended by Mr. Katz for making Aquamarine infused water is to take a necklace of Aquamarine stones or beads, hold the necklace over a collection container, and pour water over the necklace. This method has several limitations. First, if the owner of the necklace is occasionally wearing the necklace, the necklace would need to be cleaned prior to making the gemstone infused water. Cleaning the necklace makes the process more arduous because Aquamarine infused water needs to be made fresh daily. Second, pouring the water over the Aquamarine necklace allows for only brief contact between the water and the Aquamarine gemstones thus providing a limited opportunity for the energetic qualities of the Aquamarine gemstones to be imputed to the water. In fact, most of the water being poured over the Aquamarine necklace is probably not having any contact with the Aquamarine gemstones strung on the necklace. Third, if the Aquamarine necklace has a metal clasp or is strung on a metallic wire, the qualities of the metal may be imputed to the water. This will detract from or compete with the quality of the gemstone infused water produced by this process.

Other methods used to make gemstone infused water include:

(a) placing the gemstones directly into a container of water.

(b) placing small beads or chips of the gemstones into a tea bag, and dropping the tea bag into the container of water.

(c) placing the gemstones around the outside (but not inside) the container of water.

(d) placing the gemstones above (but not inside) the container of water and letting sunlight shine through the gemstones onto the container of water.

The aforementioned methods for producing gemstone infused water suffer from a number of disadvantages:

(a) In some of the aforementioned methods, the gemstones make no physical contact with the water such as where the gemstones are placed outside and around the exterior of the container of water.

(b) In some of the aforementioned methods, materials other than the gemstones and the glass containers come into contact with the water such a where the water is poured over a necklace containing a metal clasp or is strung on a metallic wire.

(c) Some of the aforementioned methods are awkward and inefficient such as where the gemstones are actually placed into the container that will hold the gemstone infused water.

(d) Most of the aforementioned methods provide no turbidity of the water flowing across and over the gemstones such as where the gemstones are placed into a tea bag or at the bottom of the container of water. Turbidity facilitates the infusion of the qualities of the gemstones into the water by increasing the percentage of the water coming into contact with the surface of gemstones.

### SUMMARY

In accordance with one embodiment, gemstones 14 are placed into a perforated glass container 10. Water 15 is then poured into the perforated glass container and over the gemstones. The water comes into contact with the gemstones, passes through the perforations 11 in the perforated glass container, and then flows or drains into a glass collection container 12 where it is collected for consumption.

### Advantages

Accordingly, several advantages of one or more aspects are as follows: a process that avoids contact of the water with materials other than glass and the gemstones, that increases contact and turbidity between the water and the gemstones, that is simple, effective, and efficient, with minimal need for cleaning and preparation. Other advantages of one or more aspects will be apparent from a consideration of the drawings and ensuing description.

### DRAWINGS—FIGURES

FIG. 1 shows a perspective view of the perforated glass container 10, with the glass collection container 12 shown below it.

FIG. 2 shows a side view of the perforated glass container 10 resting on top of the glass collection container 12.

FIG. 3 is a side view showing gemstones 14 inside the perforated glass container 10 and water 15 being poured over the gemstones whereupon the water passes through the perforations 11 in the perforated glass container and into the glass collection container 12.

### DRAWINGS—REFERENCE NUMERALS

10 perforated glass container

11 perforations in the perforated glass container

12 glass collection container

13 water that has been collected in the glass collection container

14 gemstones

15 water being poured into the perforated glass container

16 a source of water

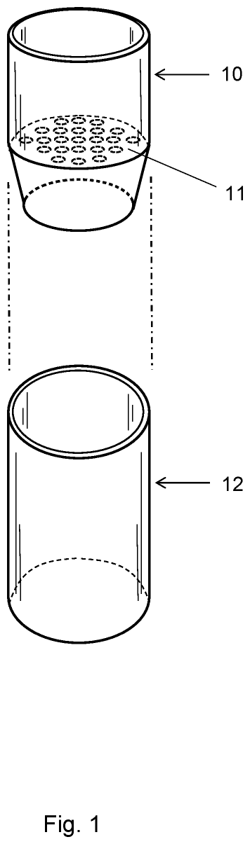

### DETAILED DESCRIPTION—FIGS. 1, 2 AND 3

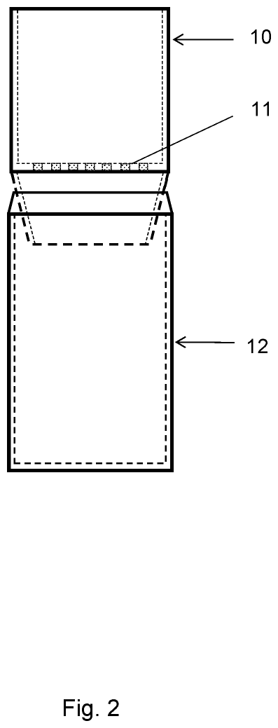

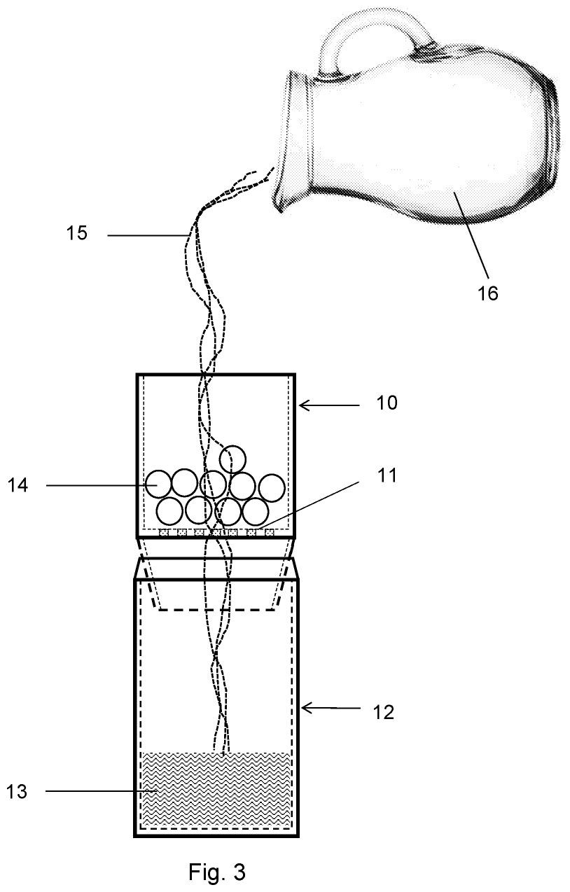

One embodiment is illustrated in FIG. 1 (perspective), FIG. 2 (side view), and FIG. 3 (side view). Gemstones 14 are placed into a perforated glass container 10. The perforations 11 are at or near the bottom of the perforated glass container. The perforated glass container is placed, rested or held above the glass collection container 12. From any source of water 16, water is poured 15 into the perforated glass container and over the gemstones. The water washes over the gemstones, and then drains through the perforations in the perforated glass container into the glass collection container where it is collected for consumption or storage. This sequence of steps can be repeated multiple times for the same batch of water or a new batch of water.

Once preparation of the gemstone infused water has been completed, the perforated glass container can be set aside for future use. The gemstones can remain inside the perforated glass container or removed. Keeping the gemstones inside the perforated glass container reduces preparation time and increases simplicity. Because the perforated glass container is not used to consume the gemstone infused water, neither it nor the gemstones need to be cleaned. The same or a different glass collection container can be used to prepare the next batch of gemstone infused water.

Although the description above contains many specificities, these should not be construed as limiting the scope of the embodiments but as merely providing illustrations of some of several embodiments. For example, the perforated glass container can have other shapes, there can be more or less perforations in the glass, the perforations can vary in size, shape, and location, and the perforated glass container can drain into and be located above the glass collection container in various ways.

Thus, in addition to the above description, the scope of the embodiments should also include the appended claims and their legal equivalents,

1. A process for making gemstone infused water using a perforated glass container comprising the following steps:
a. providing a perforated glass container;
b. placing gemstones into said perforated glass container;
c. pouring water into said perforated glass container, and over said gemstones;
d. providing a glass collection container to collect the gemstone infused water as it drains through and out of the perforations in said perforated glass container.
whereby said gemstone infused water in said glass collection container is then available for consumption or storage.

2. The perforated glass container provided in claim 1 wherein the perforated glass container into which the water is initially poured has a cylindrical shape.

3. The perforated glass container provided in claim 1 wherein the perforated glass container into which the water is initially poured has a predetermined size and cross-sectional shape.

4. The perforated glass container provided in claim 1 wherein the perforations in the perforated glass container have a predetermined number, size, spacing, and location.

5. The perforated glass container provided in claim 1 having perforations of a predetermined number, size, spacing, and location to allow the water to flow out of the perforated glass container at a predetermined rate.

6. The perforated glass container provided in claim 1 having perforations of a predetermined number, size, spacing, and location to allow the water to temporarily pool up or collect inside the perforated glass container prior to draining into the collection container.

7. The perforated glass container provided in claim 1 wherein the perforated glass container into which the water is initially poured has a cylindrical shape, and the perforations in the perforated glass container have a predetermined number, size, spacing, and location.

8. The perforated glass container provided in claim 1 wherein the perforated glass container into which the water is initially poured has a cylindrical shape, and has perforations of a predetermined number, size, spacing, and location to allow the water to flow out of the perforated glass container at a predetermined rate.

9. The perforated glass container provided in claim 1 wherein the perforated glass container into which the water is initially poured has a cylindrical shape, and has perforations of a predetermined number, size, spacing, and location to allow the water to temporarily pool up or collect inside the perforated glass container prior to draining into the collection container.

10. The perforated glass container provided in claim 1 wherein the perforated glass container into which the water is initially poured has a predetermined size and cross-sectional shape, and the perforations in the perforated glass container have a predetermined number, size, spacing, and location.

11. The perforated glass container provided in claim 1 wherein the perforated glass container into which the water is initially poured has a predetermined cross-sectional shape, and has perforations of a predetermined number, size, spacing, and location to allow the water to flow out of the perforated glass container at a predetermined rate.

12. The perforated glass container provided in claim 1 wherein the perforated glass container into which the water is initially poured has a predetermined cross-sectional shape, and has perforations of a predetermined number, size, spacing, and location to allow the water to temporarily pool up or collect inside the perforated glass container prior to draining into the collection container.

13. The perforated glass container provided in claim 1 wherein the perforated glass container into which the water is initially poured has a predetermined size and cross-sectional shape, and has perforations of a predetermined number, size, spacing, and location to allow the water to flow out of the perforated glass container at a predetermined rate.

14. The perforated glass container provided in claim 1 wherein the perforated glass container into which the water is initially poured has a predetermined size and cross-sectional shape, and has perforations of a predetermined number, size, spacing, and location to allow the water to temporarily pool up or collect inside the perforated glass container prior to draining into the collection container.

15. The perforated glass container provided in claim 1 wherein salt, at a predetermined ratio, is mixed with the water prior to pouring the water into the perforated glass container.
